(19) United States
(12) Patent Application Publication
(10) Pub. No.: US 2007/0243499 A1
(43) Pub. Date: Oct. 18, 2007

(54) Collapsible grip spindle assembly for a dental handpiece

(76) Inventor: Stanley A. Bowen, Santa Ana, CA (US)

Correspondence Address: LAW OFFICES OF MORLAND C FISCHER, 2030 MAIN ST, SUITE 1300, IRVINE, CA, 92614, US

(21) Appl. No.: 11/405,343

(22) Filed: Apr. 18, 2006

(51) Int. Cl. A61C 1/14

(52) U.S. Cl. 433/127

(57) ABSTRACT

Disclosed is a rotating spindle assembly for a dental handpiece and a hollow cylindrical collet thereof to apply a variable gripping force by which to reliably retain a dental workpiece (e.g., a bur) and thereby prevent the bur from flying out of the collet when the bur is rotated at high speeds during a dental procedure. The collet includes a pair of collet members that are divided (i.e., spaced from one another) by a pair of longitudinally extending slots that are machined into opposite sides of the cylindrical collet. The pair of collet members are pivotally connected to one another at solid pivot junctions that are located in the pairs of slots. Accordingly, the pair of collet members rotate at the pivot junctions such that proximal ends of the collet members rotate towards one another to a closed position for collapsing around the bur and increasing the gripping force on the bur, or the proximal ends of the collet members rotate away from one another to an open position for reducing the gripping force and releasing the bur.

### BACKGROUND OF THE INVENTION

1. Field of the Invention

This invention relates generally to a rotating spindle assembly for a dental handpiece and to a cylindrical collet threof having a collapsible gripping area for applying an increased gripping force by which to reliably retain a dental bur and thereby prevent the bur from flying out of the collet when the bur is rotated at high speed during a dental procedure.

2. Background Art

Compressed air driven dental pieces have long been used by dental workers to treat the teeth of their patients. Any one of a variety of dental workpieces (e.g., a dental bur) is releasably retained by a hollow cylindrical collet of a spindle assembly so as to be rotatable in response to a corresponding rotational force that is applied to the collet.

It is common for the collet to rotate the dental handpiece at speeds as high as 500,000 RPM during a dental procedure. At such high rotational speeds, the mouth of the collet has been known to open and inadvertently release the bur. Consequently, the bur may fly out of the collet while inside the mouth of the dental patient, whereby the patient could sustain serious injury to his mouth and/or teeth.

Accordingly, it would be desirable to have a spindle assembly for a dental handpiece with a collet that is capable of applying a relatively large gripping force to a dental bur to prevent the bur from being inadvertently released by the collet and flying off while rotating at high speed during use.

### SUMMARY OF THE INVENTION

In general terms, a rotatable spindle assembly is disclosed including a hollow cylindrical spindle body surrounding a hollow cylindrical collet. The collet has a collapsible gripping area at a proximal end thereof at which to apply a variable gripping force to either release or reliably retain a dental workpiece (e.g., a bur) and thereby prevent the bur from flying out of the collet while rotating at high speed during a dental procedure. The cylindrical collet comprises a pair of collet members that are spaced from one another by a pair of slots that are machined into opposite sides of the collet so as to run longitudinally and continuously between the proximal and distal ends thereof.

Each of the opposing slots that divides the pair of collet members includes a spiral located at the proximal end of the collet at which to establish the collapsible gripping area. The spiral of each slot is interrupted by a solid junction at which the pair of collet members are joined to one another. The junctions of the spirals function as pivot points around which the pair of collet members can rotate in opposite directions as lever arms between open and closed positions for adjusting the gripping force applied to the dental bur.

A collet actuator receives an axial pushing force for causing the actuator to move forwardly through the spindle body and a head of the actuator to correspondingly move forwardly through the collet surrounded by the spindle body. As the actuator head moves forwardly through the collet, a spring (e.g., a spring washer) is compressed to store energy. The actuator head rides down a tapered guide lip that extends around the distal end of the collet to enable the pair of collet members to rotate at their pivot junctions to the open position so that the opposing slots at the proximal end of the collet will be relatively wide for applying a reduced gripping force and thereby allowing the bur to be released and removed from the collet.

When the axial pushing force is removed from the collet actuator, the formerly compressed spring will expand and release its stored energy. Accordingly, the collet actuator is pushed by the expanding spring rearwardly through the spindle body, and the actuator head is correspondingly moved rearwardly through the collet. In this case, the actuator head rides up the tapered guide lip around the distal end of the collet to force the pair of collet members to rotate at their pivot junctions to the closed position. The opposing slots at the proximal end of the collet will now be relatively narrow such that the collet will collapse around and apply an increased gripping force to reliably retain the bur therewithin during rotation.

### BRIEF DESCRIPTION OF THE DRAWINGS

FIG. 1 is an exploded view of a spindle assembly for a dental handpiece including a collapsible grip collet according to a preferred embodiment of this invention;

FIG. 2 is a cross-section of the spindle assembly taken along lines 2-2 of FIG. 4 with the collapsible grip collet in an open position;

FIG. 3 is an enlarged detail of the spindle assembly taken from FIG. 2;

FIG. 4 is a proximal end view of the spindle assembly of FIG. 2;

FIG. 5 is a cross-section of the spindle assembly taken along lines 5-5 of FIG. 7 with the collapsible grip collet in a closed position;

FIG. 6 is an enlarged detail of the spindle assembly taken from FIG. 5;

FIG. 7 is a proximal end view of the spindle assembly of FIG. 5; and

FIG. 8 is a perspective view of a dental handpiece including the spindle assembly and the collapsible grip collet of the present invention for reliably retaining a dental bur.

### DESCRIPTION OF THE PREFERRED EMBODIMENT

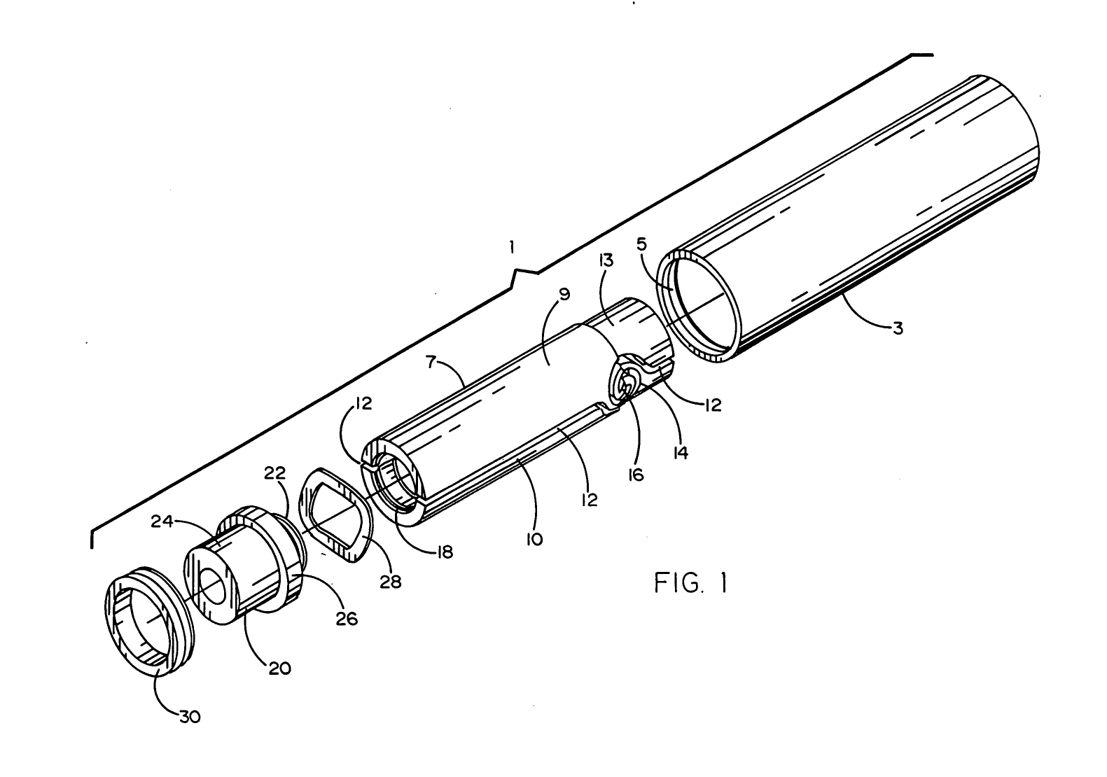

Referring initially to FIG. 1 of the drawings, there is shown a rotatable spindle assembly 1 according to the preferred embodiment for use in a dental handpiece (designated 50 and shown in FIG. 8). The spindle assembly 1 is adapted to retain a dental bur (designated 52 in FIG. 8) and other work pieces of the type that are commonly subjected to high speed rotational forces for cleaning, grinding, smoothing or drilling the teeth of a dental patient. As will soon be explained, the spindle assembly 1 is characterized by a collapsible gripping area for applying a relatively large gripping force to reliably retain the dental bur and prevent the unintended release of the bur in the mouth of a dental patient as the bur is rotating at a high speed during a dental procedure.

The spindle assembly 1 includes a hollow cylindrical spindle body 3. A groove 5 is formed around the distal end of spindle body 3. A hollow cylindrical collet 7 is sized for receipt inside the hollow spindle body 3. The collet 7 is preferably manufactured from a metal having a spring-like characteristic such as, for example, 415H stainless steel. In accordance with an important aspect of the present invention, the collet 7 has a pair of collet members (e.g., an upper collet member 9 and a lower collet member 10). The pair of collet members 9 and 10 are divided (i.e., spaced from one another) by a pair of slots 12 that are machined into opposite sides of the cylindrical collet 7 so as to run longitudinally and continuously between the proximal and distal ends thereof.

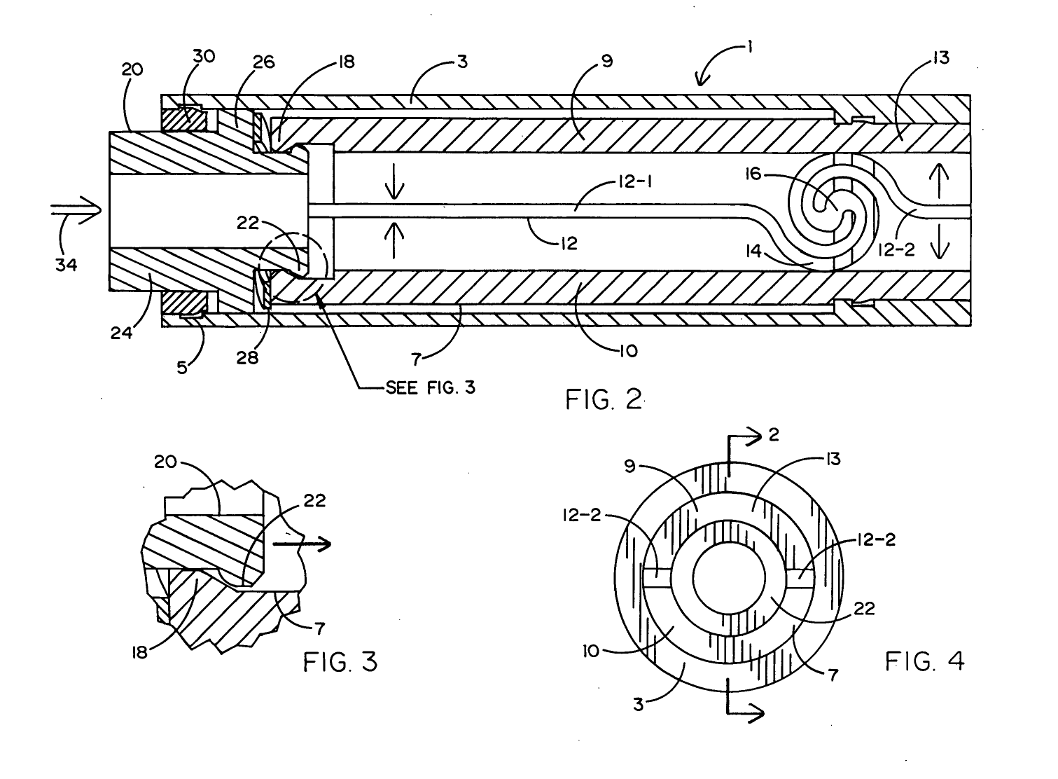

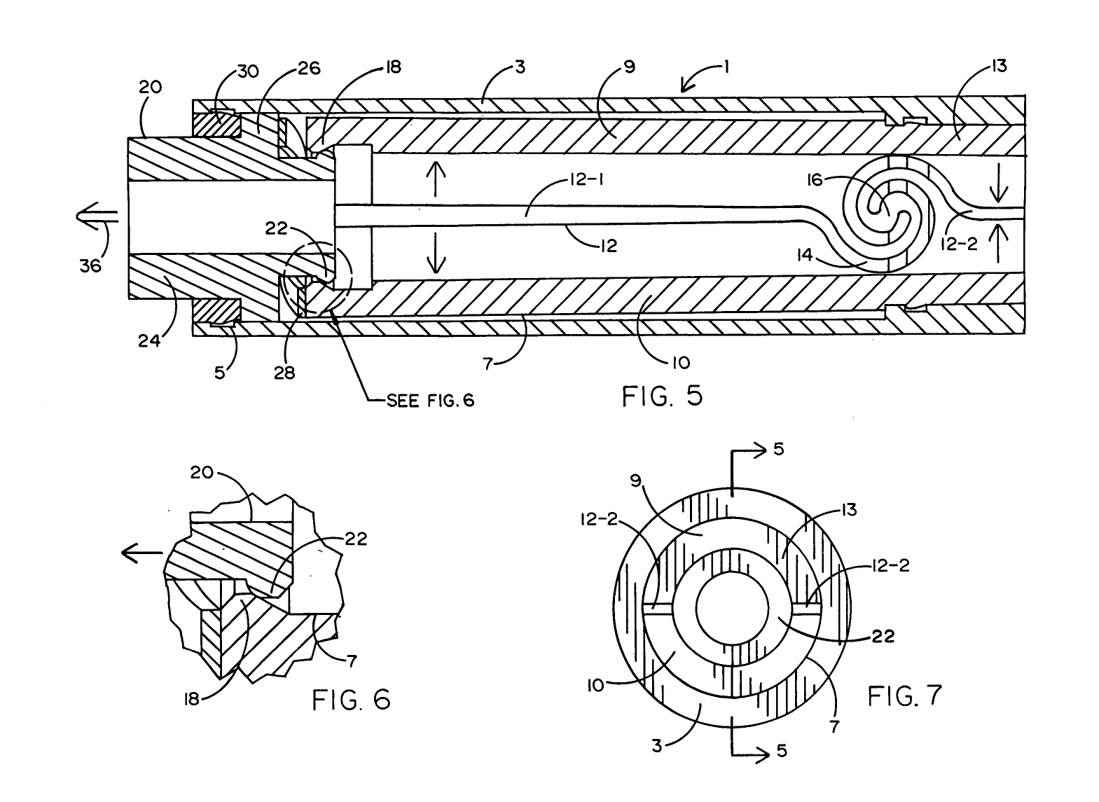

As will be disclosed in greater detail while referring to FIGS. 2-7, the pair of collet members 9 and 10 function as a pair of lever arms that are adapted to rotate relative to one another and to the spindle body 3 between open and closed positions to vary (i.e., increase or decrease) the gripping force on the dental bur. To this end, the collet 7 includes a mouth 13 at the proximal end thereof which (as is best shown in FIGS. 2 and 5) is fixedly connected to the spindle body 3 that surrounds the collet 7.

Each of the oppositely aligned slots 12 that divides the collet 7 into the pair of upper and lower collet members 9 and 10 includes a spiral 14 at the proximal end of the collet 7 that enables the mouth 13 of collet 7 to establish the collapsible gripping area of the spindle assembly 1 for reliably retaining the dental bur therewithin. The spiral 14 of each slot 12 at opposite sides of the collet 7 is interrupted by a solid junction 16 (also best shown in FIGS. 2 and 5) at which the pair of collet members 9 and 10 are joined to one another. The junctions 16 (only one of which being shown in FIGS. 2 and 5) function as pivot points around which the pair of collet members 9 and 10 can rotate to adjust the gripping force applied to the dental bur within the collapsible gripping area established by the mouth 13 of collet 7.

An inwardly projecting actuator guide lip 18 (also best shown in FIGS. 2 and 5) extends around the distal end of the collet 7. In the assembled spindle configuration, a collet actuator 20 is positioned inwardly of the distal end of the spindle body 3. The collet actuator 20 includes a head 22 that is slidably received against the actuator guide lip 18 within the distal end of collet 7 so as to ride over the lip 18 as the collet members 9 and 10 rotate between the open and closed positions relative to the spindle body 3. The collet actuator 20 also includes a push button body 24 that is located opposite the head 22. As will soon be explained, an axial pushing force applied to the push button body 24 when it is desirable to rotate the collet members 9 and 10 from the closed position to the open position will cause the collet actuator 20 to move forwardly (i.e., proximally) through the distal end of the spindle body 3 and the head 22 of actuator 20 to correspondingly ride down the actuator guiding lip 18 at the distal end of the collet. A relatively wide spring seat 26 surrounds the push button body 24 of collet actuator 20.

The spindle assembly 1 includes a spring located between the spring seat 26 of collet actuator 20 and the collet 7. By way of a preferred embodiment, the spring shown in FIG. 1 is a spring washer 28 that surrounds the head 22 and lies against the spring seat 26 of collet actuator 20. However, any other suitable spring, such as a coil spring, or the like, could be substituted for the spring washer 28. The spring washer 28 is responsive to the axial pushing force applied to the push button body 24 to cause the collet actuator 20 to move forwardly through the distal end of the spindle body 3 during which time the spring 28 will be compressed and store energy for a purpose that will soon be explained.

A fastener (e.g., snap ring 30) is snap-fit within the groove 5 at the distal end of the spindle body 1. In the assembled spindle configuration, the snap ring 30 prevents the collet actuator 20 and the spring washer 28 from being removed outside the distal end of the spindle body 3.

Turning to FIGS. 2-4 of the drawings, the spindle assembly 1 is shown with the pair of rotatable collet members 9 and 10 of collet 7 in the open position so that a dental bur can be inserted or removed at which time the collapsible gripping area established by the mouth 13 of collet 7 is expanded so that a reduced gripping force is applied to the bur. To place the pair of collet members 9 and 10 in the open position, the aforementioned manual pushing force is applied (in the direction of the reference arrow 34 of FIG. 2) to the push button body 24 of collet actuator 20. The pushing force causes the collet actuator 20 to slide forwardly (i.e., proximally) through the spindle body 3 and away from the snap ring 30, whereby the spring washer 28 is compressed (i.e., flattened) between the spring seat 26 of actuator 20 and the collet 7. As long as the pushing force 34 is applied to the collet actuator 20, the spring washer 28 will continue to store energy.

At the same time that the collet actuator 20 slides forwardly through the spindle body 3, the head 22 of actuator 20 will correspondingly move forwardly (i.e., proximally) through the distal end of the collet 7. Accordingly, the head 22 will ride over the inwardly projecting actuator guide lip 18 of collet 7. As is best shown in FIG. 3, the actuator guide lip 18 is inwardly tapered from wide to narrow. Therefore, the head 22 will ride down the tapered actuator guide lip 18 in response to the pushing force 34 applied to collet actuator 20.

With the head 22 at the bottom of the actuator guide lip 18 as shown in FIG. 3, the pair of collet members 9 and 10 will rotate relative to one another within the spindle body 3 to the open position. The spirals 14 of the opposing slots 12 which divide the pair of collet members 9 and 10 function as wound springs for inducing the collet members to rotate as lever arms around the solid junctions (i.e., pivot points) 16 that interrupt the spirals 14 and join the collet members 9 and 10 to one another. That is, the spirals 14 are wound so as to be stressed when the collet members 9 and 10 are in the open position, whereby to bias the collet members to rotate towards the closed position (of FIGS. 5-7).

In the case (as shown in FIGS. 2-4) where the head 22 of collet actuator 20 is moved down to the bottom of the tapered guide lip 18 of collet 7, the pair of collet members 9 and 10 will rotate in opposite directions around junctions 16 such that the portion 12-1 of each of the opposing slots 12 that is located distally of the junction 16 will become relatively narrow, and the portion 12-2 of each slot 12 that is located proximally of junction 16 will become relatively wide. Because the proximal portions 12-2 of the slots 12 are now wide (best shown in FIG. 4), the mouth 13 at the proximal end of the collet 7 is open, and the gripping force generated by the mouth will be reduced. Hence, the dental bur may be easily removed from or attached to the spindle assembly 1 at the open proximal end (i.e., mouth 13) of the collet 7.

Referring now to FIGS. 5-7 of the drawings, the spindle assembly 1 is shown with the pair of collet members 9 and 10 rotated to the closed position at which time the collapsible gripping area at the mouth 13 of collet 7 is collapsed so that an increased gripping force is generated to reliably retain the dental bur and prevent the bur from being ejected from the collet 7 as it rotates at high speed during a dental procedure. The collet members 9 and 10 are automatically rotated to the closed position when the manual pushing force (designated 34 in FIG. 2) is removed from the push button body 24 of collet actuator 20.

Once the pushing force is terminated, the collet actuator 20 will slide rearwardly (i.e., distally) through the spindle body 3 (in the direction of reference arrow 36 of FIG. 5). That is to say, the spring washer 28 which was previously compressed (i.e., flattened), can now expand between the spring seat 26 of actuator 20 and the collet 7 so as to release its stored energy. Because the collet 7 (at its mouth 13) is fixedly connected within the spindle body 3, the expansion of the spring washer 28 causes the body 24 of collet actuator 20 to be pushed towards the snap spring 30.

At the same time that the collet actuator 20 moves rearwardly through the spindle body 3, the head 22 of actuator 20 will correspondingly move rearwardly through the distal end of the collet 7. Accordingly, the head 22 of actuator 20 will ride up the tapered actuator guide lip 18 of collet 7. As the head 22 approaches the top of the actuator guide lip 18 as shown in FIG. 6, the pair of collet members 9 and 10 of collet 7 will rotate within the spindle body 3 to the closed position.

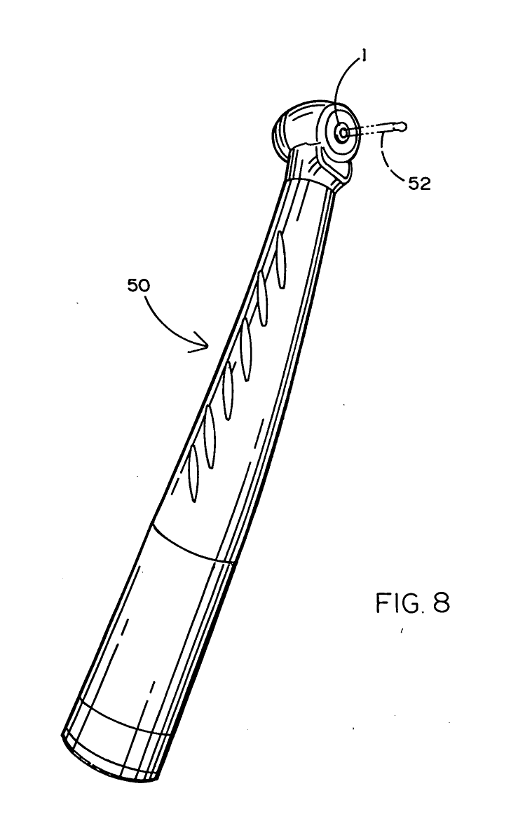

More particularly, in the case (as shown in FIGS. 5-7) where the head 22 of collet actuator 20 rides up the tapered guide lip 18 of collet 7, an outward pushing force is applied from the head 22 to each of the pair of collet members 9 and 10 at the distal end of the collet. The pushing force causes the collet members 9 and 10 to rotate in opposite directions relative to one another at the solid junctions (i.e., pivot points) 16 which interrupt the spirals 14 of the slots 12 formed in opposite sides of the collet 7. Accordingly, the portions 12-1 of the slots 12 that are located distally of the junctions 16 will now be relatively wide, and the portions 12-2 of the slots 12 that are located proximally of the junctions 16 will become relatively narrow (best shown in FIG. 7).

Because the proximal portions 12-2 of each of the opposing slots 12 shown in FIGS. 5 and 7 have been narrowed (with respect to the relatively wide proximal portions 12-2 as shown in FIGS. 2 and 4), the proximal end of the collet 7 will collapse around the bur, and the gripping force generated by the collapsible gripping area (i.e., mouth 13) of collet 7 will increase. Hence, the dental bur cannot be easily removed or become detached from the spindle assembly 1 at the closed proximal end of collet 7.

What is more, as the bur is rotated at very high speeds, centrifugal force will continue to drive the collet actuator 20 towards the snap spring 30 (in the direction of reference arrow 36) so that the head 22 of actuator 20 will be pulled to the top of the actuator guide lip 18. Thus, the collet members 9 and 10 at the distal end of collet 7 will be forced outwardly towards the spindle body 3, and the width of the distal portions 12-1 of the opposing slots 12 between the collet members 9 and 10 will be maximized. At the same time, the width of the proximal portions 12-2 of the opposing slots 12 will be minimized for fully collapsing the mouth 13 at the proximal end of the collet 7 tightly around the bur. By virtue of the foregoing, the bur will be reliably retained by the spindle assembly 1 and will be unlikely to fly out of the collet 7 during use.

1. A spindle assembly for a dental handpiece, said spindle assembly comprising a collet within which to releasably receive a dental workpiece to be rotated for performing a dental operation on the teeth of a patient, said collet having opposite proximal and distal ends, said collet having a closed position at which the proximal end thereof collapses around the dental workpiece to apply a gripping force for retaining the workpiece and an open position at which said proximal end expands and thereby reduces said gripping force for releasing the workpiece.

2. The spindle assembly recited in claim 1, further comprising a spindle sleeve surrounding said collet and spaced therefrom, the proximal end of said collet moving inwardly relative to and away from said spindle sleeve to said closed collet position so as to collapse around the dental workpiece, and said proximal end expanding and moving outwardly towards said spindle sleeve to said open collet position so as to release the workpiece.

3. The spindle assembly recited in claim 1, wherein said collet includes at least first and second collet members, each of said collet members having a proximal end and a distal end and being spaced from one another by at least first and second longitudinally extending slots, said first and second collet members being pivotally connected to one another such that the proximal ends thereof rotate in opposite directions between the closed and open positions of said collet.

4. The spindle assembly recited in claim 3, wherein said first and second collet members are pivotally connected to one another at respective pivots located within said first and second slots, such that the proximal end of each of said first and second collet members rotates in a direction relative to said slots that is opposite to the direction of rotation of the distal end thereof.

5. The spindle assembly recited in claim 4, wherein each of said first and second slots includes a spiral section, each of said spiral sections having a solid junction located therein to establish said pivots at which said first and second collet members are pivotally connected to one another and at which said first and second collet members are rotated.

6. The spindle assembly recited in claim 5, wherein said collet is manufactured from a material having a spring memory, and said spiral sections of said first and second slots function as wound springs for biasing said collet to the closed collet position by urging the proximal ends of said first and second collet members to rotate at said pivots towards one another for collapsing around the dental workpiece and thereby reducing the width of said first and second slots and the distal ends of said first and second collet members to rotate away from one another for increasing the width of said first and second slots.

7. The spindle assembly recited in claim 4, further comprising a collet actuator received by the distal end of said collet, said collet actuator being responsive to a pushing force applied thereagainst for moving in a proximal direction through said collet and enabling the distal ends of said first and second collet members to rotate towards one another and the proximal ends of said first and second collet members to rotate away from one another, whereby to reduce the gripping force applied by said collet to the dental workpiece.

8. The spindle assembly recited in claim 7, wherein said collet actuator is adapted to move in a distal direction through said collet when said pushing force is removed therefrom for urging the distal ends of said first and second collet members to rotate away from one another and the proximal ends of said first and second collet members to rotate towards one another, whereby to increase the gripping force applied to the dental workpiece.

9. The spindle assembly recited in claim 8, further comprising a spring located between said collet actuator and the distal end of said collet, said spring being compressed to store energy when said collet actuator moves in said proximal direction through said collet in response to said pushing force, and said spring expanding and releasing its stored energy for forcing said collet actuator to move in said distal direction through said collet when said pushing force is removed from said collet actuator.

10. The spindle assembly recited in claim 8, wherein the distal end of said collet through which said collet actuator is moved has a tapered lip extending therearound, said collet actuator riding down said tapered lip for enabling said first and second collet members to rotate to the open collet position to reduce the gripping force applied to the dental workpiece when said collet actuator moves in said proximal direction through said collet, and said collet actuator riding up said tapered lip for urging said first and second collet members to rotate to the closed collet position to increase the gripping force applied to the dental workpiece when said collet actuator moves in said distal direction through said collet.

11. A spindle assembly for a dental workpiece, said spindle assembly comprising a hollow collet within which to releasably receive a dental workpiece to be rotated for performing a dental operation on the teeth of a patient, said collet including at least first and second collet members, each of said first and second collet members having a proximal end and a distal end and being spaced from one another by at least first and second slots, said first and second collet members being pivotally connected to one another such that the proximal ends thereof are rotated in a direction relative to said slots that is opposite the direction in which the distal ends thereof are rotated, said first and second collet members being pivotally connected to one another at respective pivots located within said first and second slots.
